(19) United States
(12) Patent Application Publication
(10) Pub. No.: US 2020/0323395 A1
(43) Pub. Date: Oct. 15, 2020

(54) Sandwich Making Utensil

(71) Applicant: Sahar Dawn Ojan, Warminster, PA (US)

(72) Inventor: Sahar Dawn Ojan, Warminster, PA (US)

(21) Appl. No.: 16/809,124

(22) Filed: Mar. 4, 2020

Related U.S. Application Data
(60) Provisional application No. 62/832,277, filed on Apr. 10, 2019.

(51) Int. Cl. A47J 43/28; A21D 13/32

(52) U.S. Cl. CPC A47J 43/28; A21D 13/32

(57) ABSTRACT

A sandwich making utensil includes a tubular shell, a bottom support surface for supporting the sandwich stack received in the tubular shell, and a pusher or plunger for ensuring that all the items in the sandwich stack are packed close together with no gaps in between. The tubular shell has two pieces that are hinged together on one side with a hinge axis that is parallel to the longitudinal axis of the tubular shell and that can be selectively secured together in the closed position or configuration by a latch provided on the side of the tubular shell opposite the hinge, which allows the shell to be opened for easy removal of the completed sandwich. The cross sectional shape and size of the bore of the tubular shell are configured for corresponding to a predetermined type of sandwich bread.

### BACKGROUND OF THE INVENTION

### 1. Field of the Invention

The present invention relates to a utensil for stacking breads and filings such as meats, cheeses, vegetables, condiments, sauces, pickles and other accompaniments into a sandwich without these items sliding off the sandwich stack.

### 2. Description of the Prior Art

When making a sandwich using bread types, such as round rolls, toast, buns, and loaves sliced transversely to the loaves' longitudinal axis into multiple slices, referred to herein as sliced loaves, and the like, it is customary to start with a piece of bread at the bottom, place in a stack on the bottom piece of bread any desired variety of sandwich fillings, such as meats, cheeses, vegetables, condiments, sauces, pickles and other accompaniments, on the bottom piece of bread and then finish the sandwich by placing a piece of bread on top of the sandwich stack. However, very often the items in the sandwich stack have a tendency to slide of the stack because the items are slippery or are made slippery by the application of sauces and condiments. This can result in quite a mess with sauces, condiments, and grease getting on the food preparation counter and on the outside of the pieces of bread, which is highly undesirable from the point of view of a diner having to hold the sandwich while eating it because the sauces, condiments, and grease would get on the diner's hands and often the diner's clothing. The sandwich maker's task is made more difficult because the person making the sandwich has to use one hand to keep the sandwich stack from falling apart, which leaves only one hand free for adding fillings to the sandwich. The added effort required to keep the sandwich stack from collapsing, adds to the difficulty of making the sandwich. This is particularly true of sandwiches that are stacked relatively high. The inconvenience of the sandwich maker having to use one hand to keep the stack together has persisted in the sandwich making art.

### SUMMARY OF THE INVENTION

The present invention is directed to a sandwich making utensil that includes a tubular shell or sleeve, a bottom support surface for supporting the sandwich stack received in the tubular shell, and a pusher or plunger for ensuring that all the items in the sandwich stack are packed close together with no gaps in between. The tubular shell has two pieces that are hinged together on one side with a hinge axis that is parallel to the longitudinal axis of the tubular shell and that can be selectively secured together in the closed position or configuration by a latch provided on the side of the tubular shell opposite the hinge, which allows the shell to be opened for easy removal of the completed sandwich. The cross sectional shape and size of the bore of the tubular shell are configured for corresponding to a predetermined type of sandwich bread, which may preferably be a selected one of the more popular types of sandwich bread. For example, the cross sectional shape and size of the bore of the tubular shell may be circular and be sized to correspond to either the standard round hamburger bun or a number of commonly available sizes of Kaiser rolls, or the cross sectional shape and size of the bore of the tubular shell may be rectangular and be sized to correspond to a large number of commonly available sizes of toast and/or sliced loaves.

### BRIEF DESCRIPTION OF THE DRAWINGS

FIGS. 1-6 are views of a first embodiment of the sandwich making utensil.

FIGS. 7-13 are views of the component parts of the first embodiment of the sandwich making utensil.

FIGS. 14-19 are views of a second embodiment of the sandwich making utensil.

FIGS. 20-26 are views of the component parts of the second embodiment of the sandwich making utensil.

Similar reference characters denote corresponding features consistently throughout the attached drawings.

### DETAILED DESCRIPTION OF THE PREFERRED EMBODIMENTS

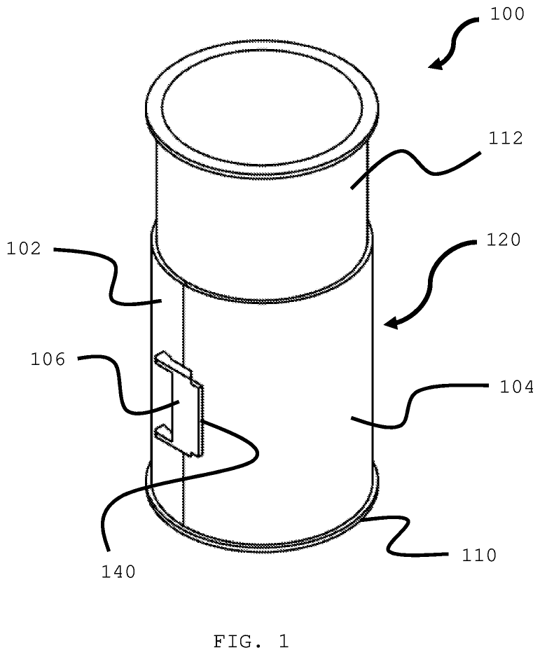

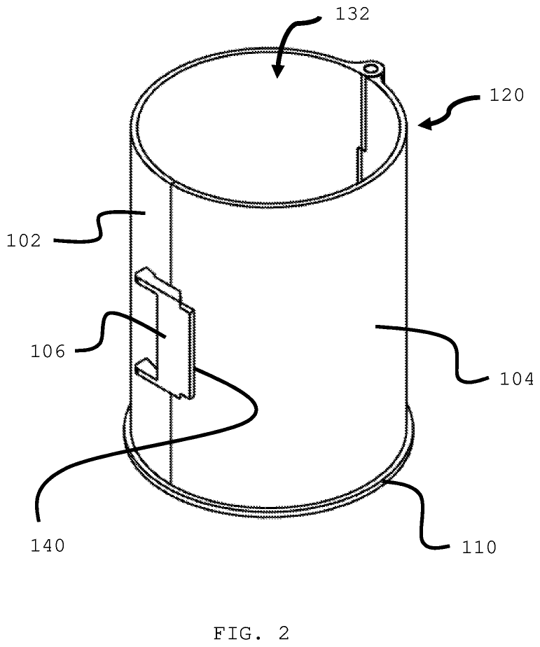

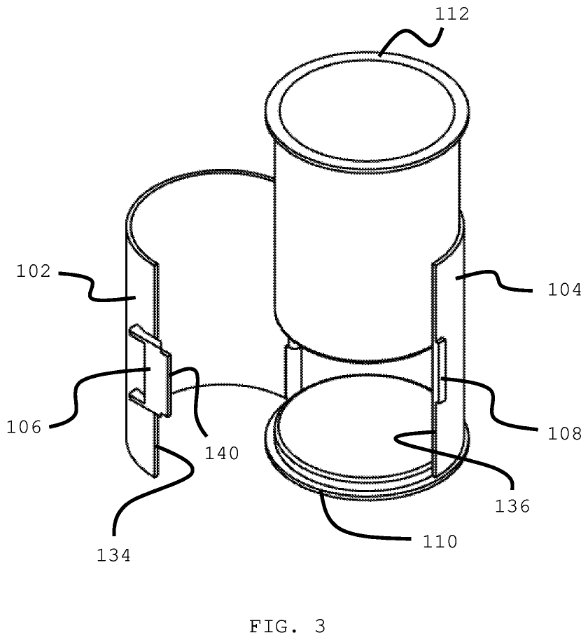

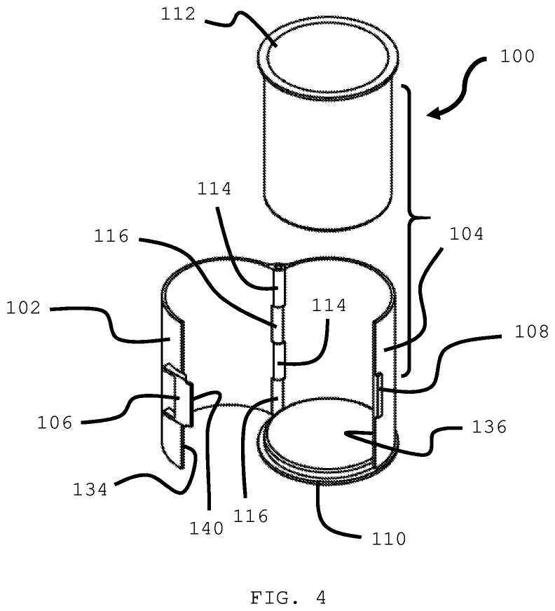

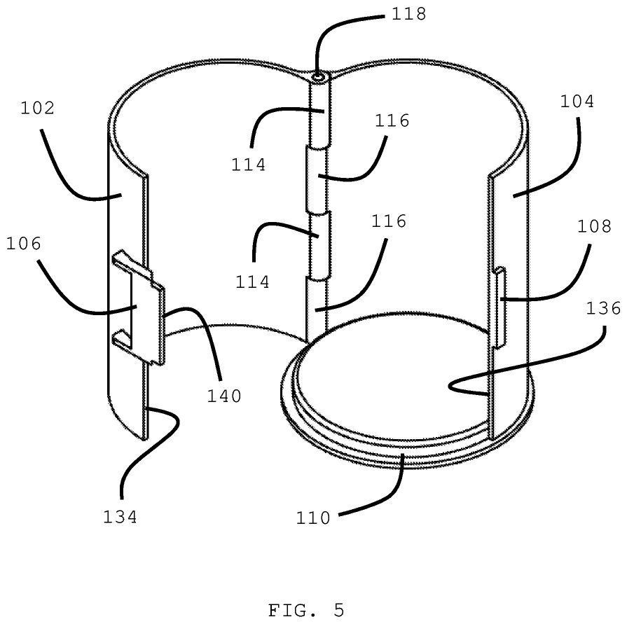

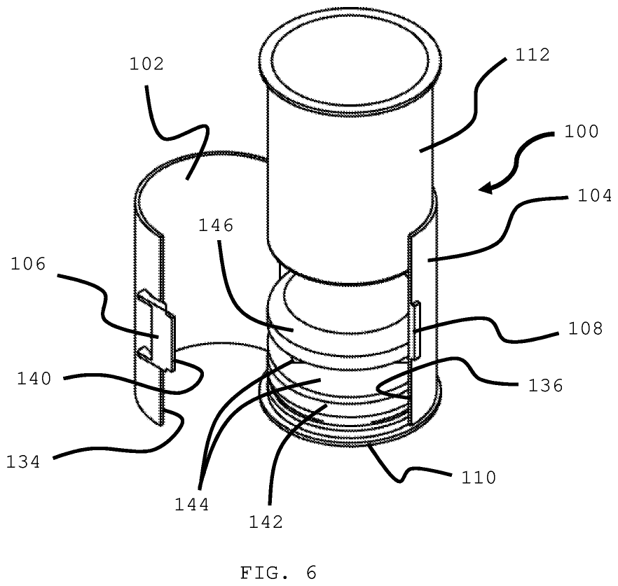

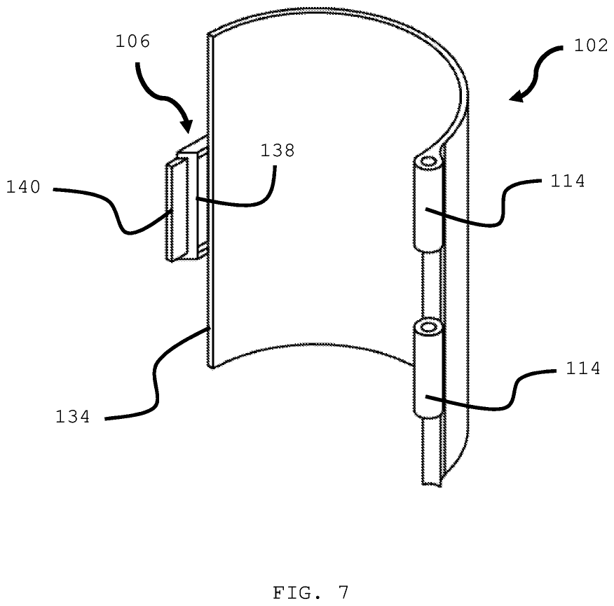

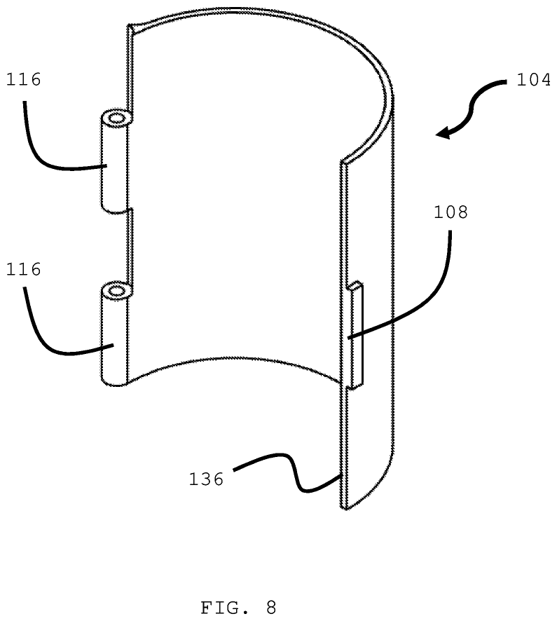

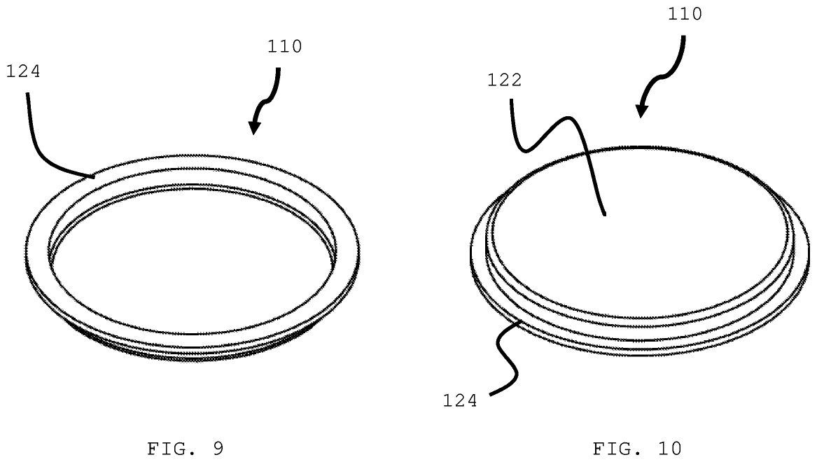

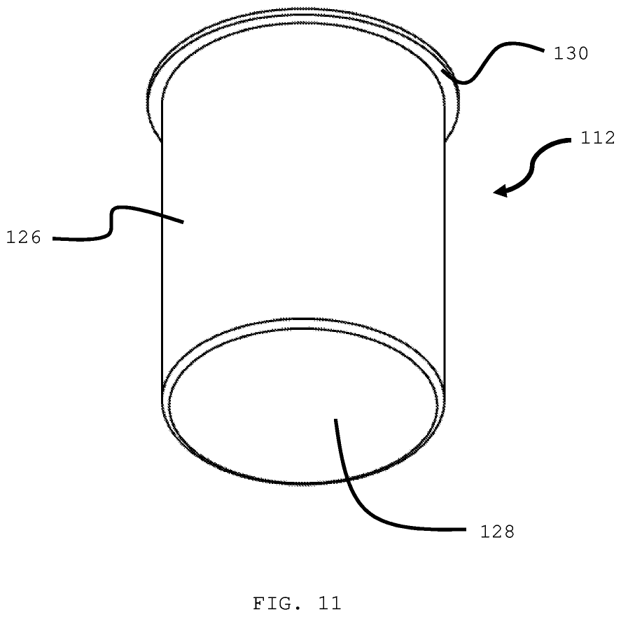

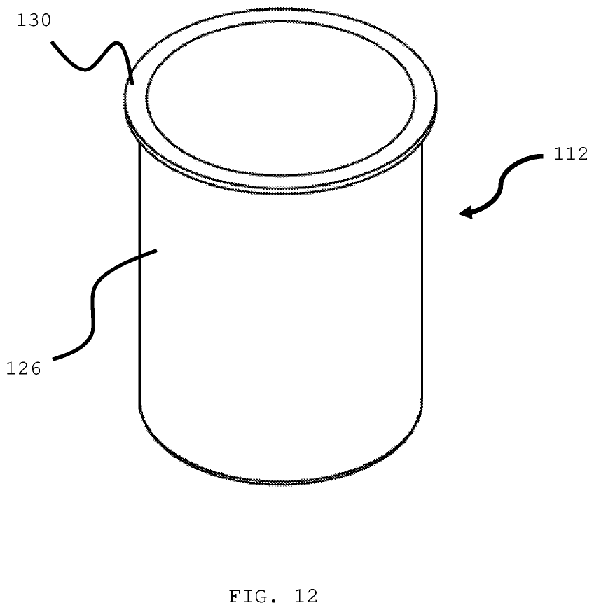

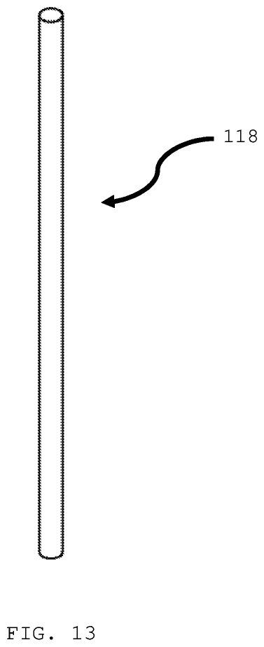

Referring to FIGS. 1-13, an embodiment 100 of the Sandwich Making Utensil can be seen. The Sandwich Making Utensil 100 is configured for making a sandwich including a sandwich stack made up of items selected from sandwich breads and sandwich fillings. The Sandwich Making Utensil 100 includes a first half shell 102, a second half shell 104, a latch 106, and a keeper 108.

The second half shell 104 is hinged to the first half shell 102. The first half shell 102 and the second half shell 104 are movable relative to each other between an open configuration and a closed configuration. The first half shell 102 and the second half shell 104 form a tubular shell 120, which has a bore, a longitudinal axis, and at least an open top when the first half shell 102 and the second half shell 104 are in the closed configuration. The bore 132 of the tubular shell 120 has a cross sectional shape and size. The cross sectional shape and size of the bore of the tubular shell 120 is configured for receiving a predetermined type of sandwich bread of a predetermined size range. In the sandwich making utensil 100, the cross sectional shape of the bore of the tubular shell 120 is circular for use with round types of sandwich bread.

The first half shell 102 and the second half shell 104 are hinged together to move pivotally relative to each other between the open configuration and the closed configuration about a hinge axis. The hinge axis is parallel to the longitudinal axis of the tubular shell 120, and the hinge axis is located on one side of the tubular shell 120.

A latch 106 is provided on the first half shell 102. A keeper 108 is provided on the second half shell 104. The latch 106 is capable of engaging the keeper 108 in order to secure the first half shell 102 and the second half shell 104 together in the closed configuration. The latch 106 is also capable of being disengaged from the keeper 108 in order to allow movement of the first half shell 102 and the second half shell 104 relative to each other so that the first half shell 102 and the second half shell 104 are then capable of being moved to the open configuration.

In the illustrated embodiment, the first half shell 102 is provided with one or more hinge barrels 114 on one side. The second half shell 104 is provided with one or more hinge barrels 116 on one side. The hinge barrels 114 of the first half shell 102 are in interdigitating relationship with the hinge barrels 116 of the second half shell 104 when more than one hinge barrel is provided on one of the first half shell 102 and the second half shell 104 such that at least one barrel on one half shell is positioned between two barrels on the other half shell. The hinge barrels 114 of the first half shell 102 are in alignment with the hinge barrels 116 of the second half shell 104 such that the bores of the hinge barrels 114 of the first half shell 102 are in alignment with the bores of the hinge barrels 116 of the second half shell 104. A hinge pin 118 is positioned to extend through the bores of the hinge barrels 114 of the first half shell 102 and the bores of the hinge barrels 116 of the second half shell 104 to thereby hinge or pivotally connect or attach the first half shell 102 to the second half shell 104. The hinge pin 118 defines the hinge axis of the hinged connection between the first half shell 102 and the second half shell 104 in that the hinge axis of the hinged connection between the first half shell 102 and the second half shell 104 coincides with the central longitudinal axis of the hinge pin 118.

When the first half shell 102 and the second half shell 104 are in the closed configuration and the latch 106 is engaged to the keeper 108, the latch 106 overlaps portions of both the first half shell 102 and the second half shell 104 on a side of the tubular shell 120 opposite the side of the tubular shell 120 on which the hinge axis is located.

The sandwich making utensil 100 further includes a bottom support 110 configured for supporting a sandwich stack received in the tubular shell 120. Each of the first half shell 102 and the second half shell 104 has a bottom, and the bottom support 110 is fixed to one of the first half shell 102 and the second half shell 104 at the bottom of the one of the first half shell 102 and the second half shell 104.

Alternatively, the tubular shell 120 has an open bottom when the first half shell 102 and the second half shell 104 are in the closed configuration, and the bottom support 110 fits in part into the bore of the tubular shell 120 to provide a closure for the open bottom of the tubular shell 120. In the illustrated embodiment, the bottom support 110 is in the form of a raised platform 122 having a perimeter and having a flange 124 of lower height around its perimeter.

The sandwich making utensil 100 also includes a pusher 112 configured for ensuring that all the items in the sandwich stack are packed close together with no gaps in between. The pusher 112 includes an elongated portion 126 configured for being capable of insertion into the bore of the tubular shell 120 to push the items in the sandwich stack together to eliminate any gaps between the items. The elongated portion 126 of the pusher 112 is preferably long enough to reach to the bottom support 110 through the bore of the tubular shell 120 without the pusher 112 falling completely into the bore of the tubular shell 120; however, the elongated portion 126 of the pusher 112 may be shorter than that length by an amount up to the height or thickness of the thinnest sandwich for which the use of the sandwich making utensil 100 is contemplated. In the illustrated embodiment, the pusher 112 has a bottom pushing surface 128 and a flange 130 projecting laterally from the perimeter of the top end of the pusher 112. The flange 130 at the top end of the pusher 112 is particularly useful for preventing pushers 112 having elongated portions 126 that are shorter than the height of the tubular shell 120 above the bottom support 110 from falling completely into the bore of the tubular shell 120.

In use, the sandwich making utensil 100 is first placed in the closed configuration by bringing together the edges 134 and 136 of the first half shell 102 and of the second half shell 104 that are on the side of each half shell that is located opposite the side of each half shell on which the hinge is located. The sandwich making utensil 100 is then secured in the closed configuration by engaging the latch 106 with the keeper 108.

In the illustrated example, the latch 106 is integral or of one-piece construction with the first half shell 102. Also, the keeper 108 is integral or of one-piece construction with the second half shell 104. The latch 106 includes a catch bar 138 of saw-tooth cross section. The latch 106 is flexible enough to allow the catch bar 138 to move between engaged and disengaged positions. The latch 106 is sufficiently resilient such that the internal resilience of the latch 106 returns the catch bar 138 from the disengaged position to the engaged position. As the edges 134 and 136 of the first half shell 102 and of the second half shell 104 are brought together, the catch bar 138 slips over the keeper 108 and moves behind the keeper, on the side of the keeper opposite the side of the keeper facing toward the edge 134 of the first half shell 102, such that the keeper 108 is captured between the catch bar 138 and the edge 134 of the first half shell 102, thus securing the two half shells in the closed configuration. The latch 106 also includes a tab 140 that allows a user to lift the catch bar 138 out of engagement with the keeper 108 in order to allow the half shells 102 and 104 to be moved relative to each other and to the open configuration.

Once the first half shell 102 and the second half shell 104 are secured in the closed configuration, the bottom support 110 will close off the bottom of the tubular shell 120, if the bottom support 110 is fixed to one of the half shells 102 and 104. If the bottom support 110 is a separate piece, then it can be inserted into the bottom of the tubular shell 120 to close off the bottom of the tubular shell 120. The tubular shell 120 is then placed on a counter top or table top with the bottom support 110 at the bottom of the tubular shell 120 adjacent the counter top or table top.

A piece of sandwich bread 142 can now be dropped down the bore of the tubular shell 120. If necessary, the pusher 112 can be used to properly seat the piece of sandwich bread 142 on the bottom support 110. Sandwich fillings 144 are then stacked on the piece of sandwich bread 142, one layer after another. The pusher 112 is used as necessary to pack the layers in the stack together such that there are no gaps between the layers. Finally, another piece of sandwich bread 146 is placed on top of the stack, with the pusher 112 being used to properly seat the piece of sandwich bread 146 on top of the stack if necessary.

Once the stacking of the sandwich ingredients is complete, the tubular shell 120 is opened up to allow removal of the completed sandwich from the sandwich making utensil 100. The sandwich can then be served, or it may be heated and/or further processed and then served depending on the recipe used or the wishes of the person who will eat the sandwich.

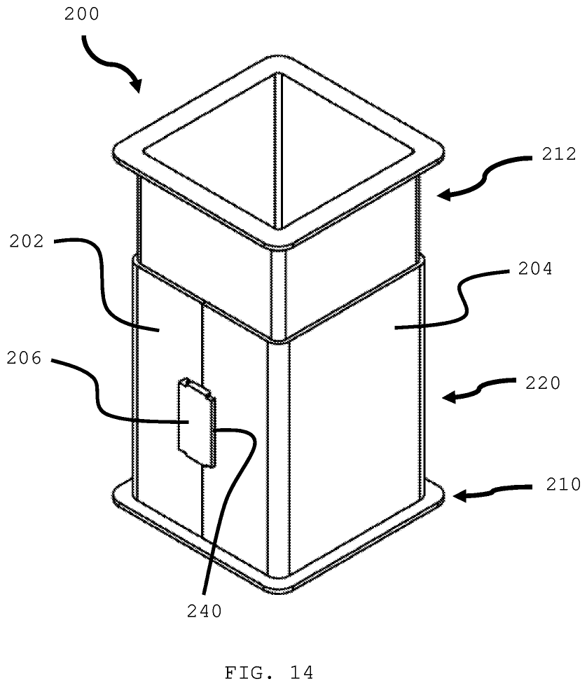

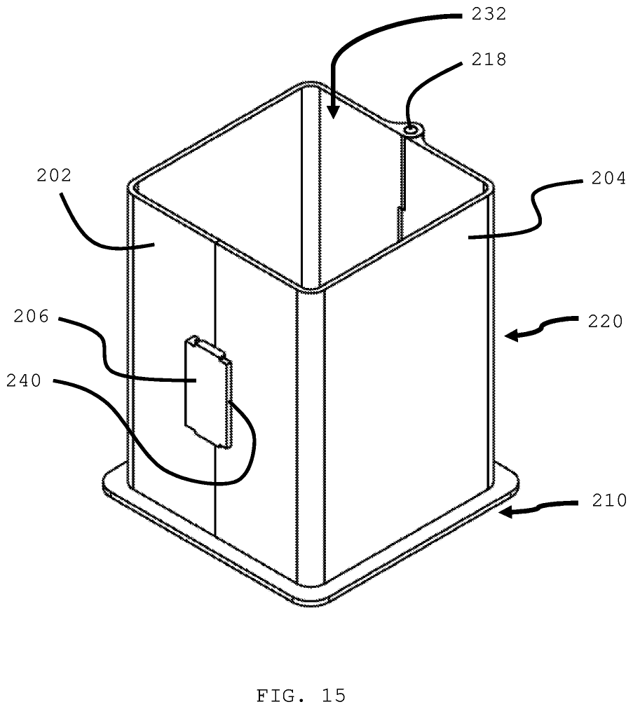

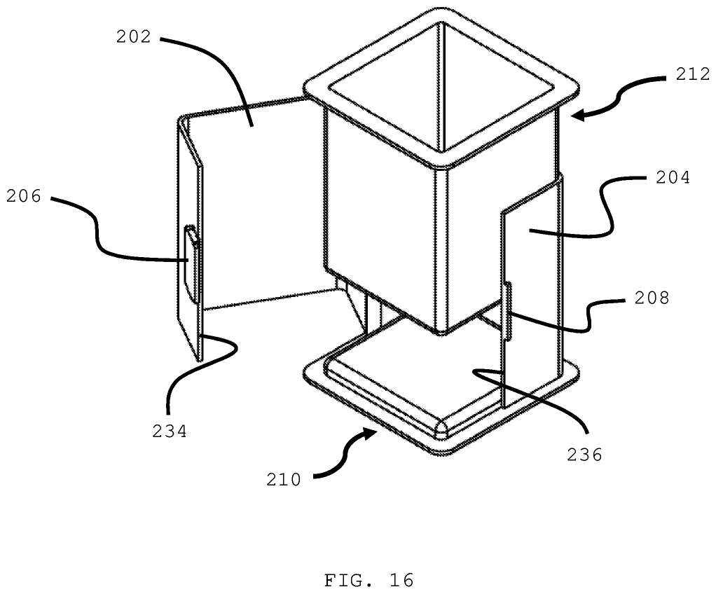

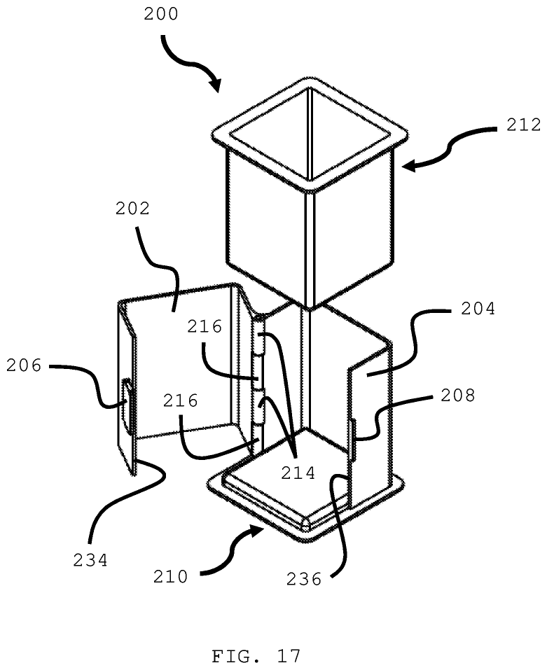

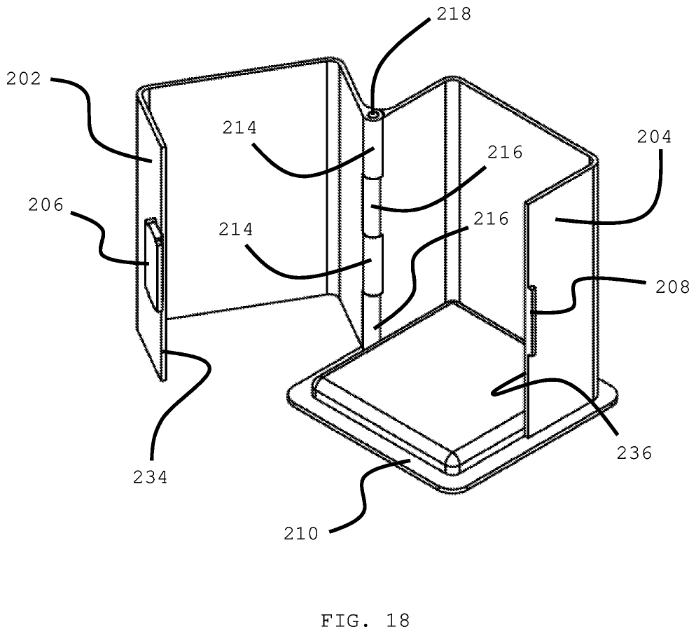

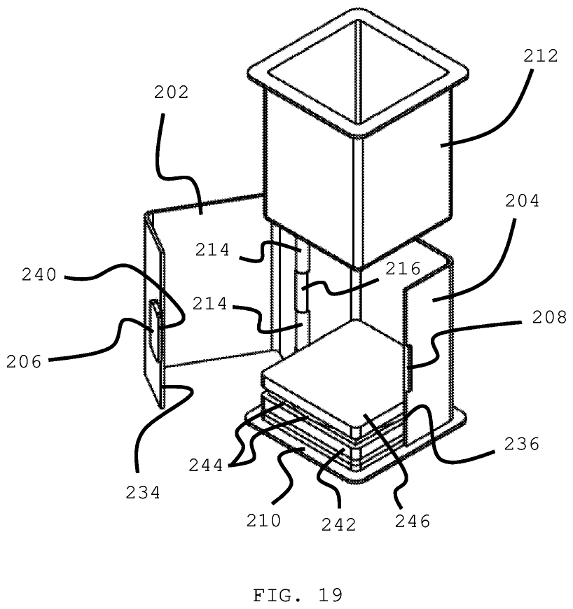

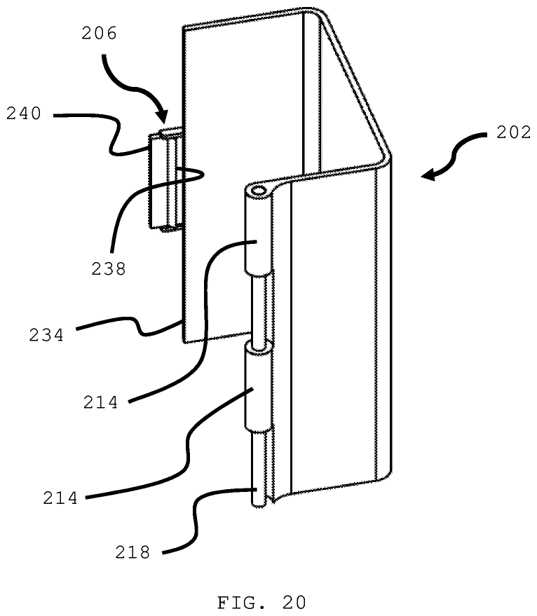

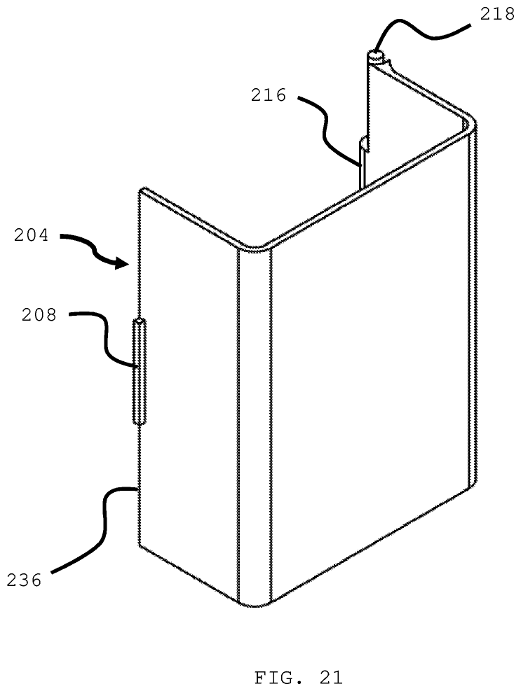

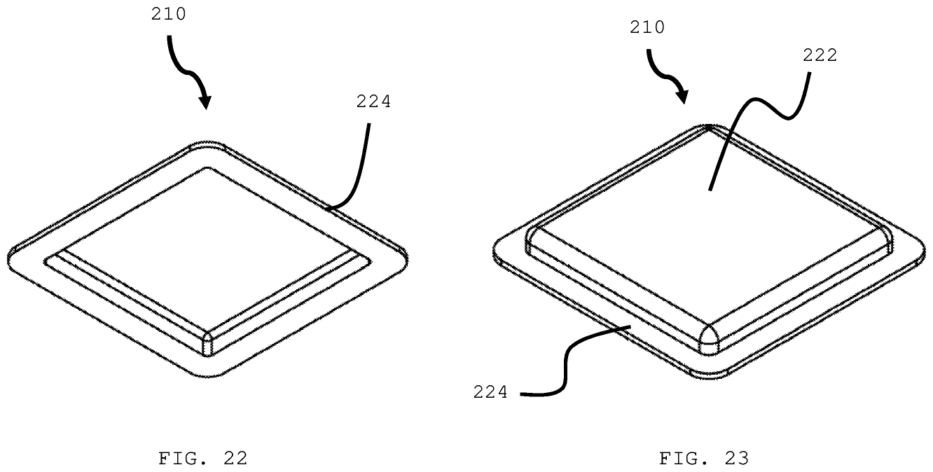

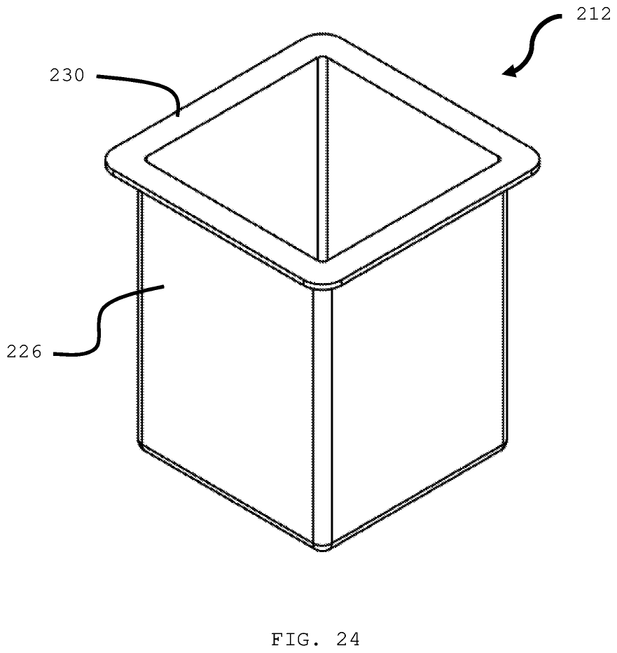

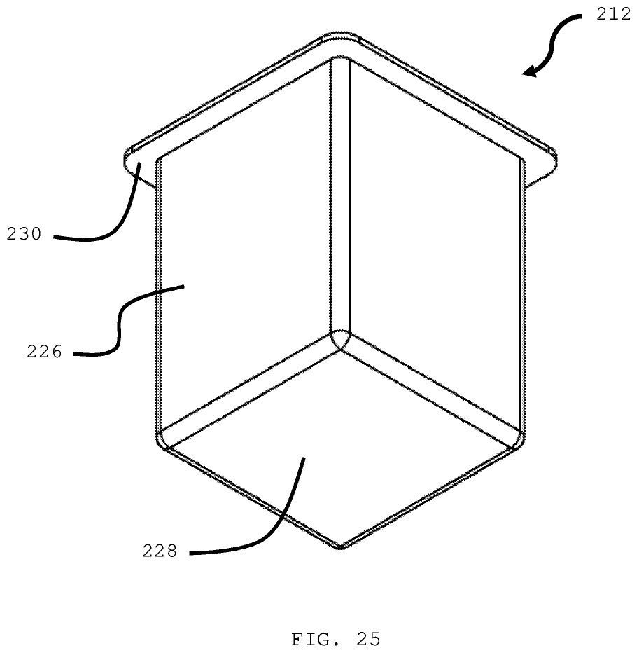

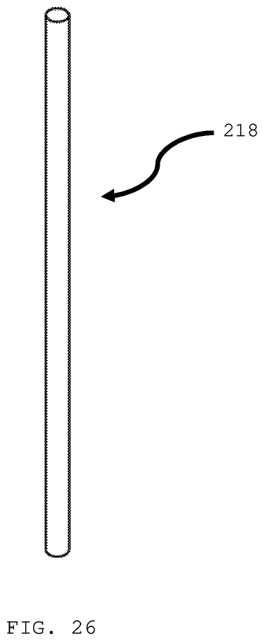

Referring to FIGS. 14-26, a second embodiment 200 of the Sandwich Making Utensil can be seen. The Sandwich Making Utensil 200 is configured for making a sandwich including a sandwich stack made up of items selected from sandwich breads and sandwich fillings. The Sandwich Making Utensil 200 includes a first half shell 202, a second half shell 204, a latch 206, and a keeper 208.

The second half shell 204 is hinged to the first half shell 202. The first half shell 202 and the second half shell 204 are movable relative to each other between an open configuration and a closed configuration. The first half shell 202 and the second half shell 204 form a tubular shell 220, which has a bore, a longitudinal axis, and at least an open top when the first half shell 202 and the second half shell 204 are in the closed configuration. The bore 232 of the tubular shell 220 has a cross sectional shape and size. The cross sectional shape and size of the bore of the tubular shell 220 is configured for receiving a predetermined type of sandwich bread of a predetermined size range. In the sandwich making utensil 200, the cross sectional shape of the bore of the tubular shell 220 is rectangular with rounded corners for use with rectangular types of sandwich bread.

The first half shell 202 and the second half shell 204 are hinged together to move pivotally relative to each other between the open configuration and the closed configuration about a hinge axis. The hinge axis is parallel to the longitudinal axis of the tubular shell 220, and the hinge axis is located on one side of the tubular shell 220.

A latch 106 is provided on the first half shell 202. A keeper 208 is provided on the second half shell 204. The latch 206 is capable of engaging the keeper 208 in order to secure the first half shell 202 and the second half shell 204 together in the closed configuration. The latch 206 is also capable of being disengaged from the keeper 208 in order to allow movement of the first half shell 202 and the second half shell 204 relative to each other so that the first half shell 202 and the second half shell 204 are then capable of being moved to the open configuration.

In the illustrated embodiment, the first half shell 202 is provided with one or more hinge barrels 214 on one side. The second half shell 204 is provided with one or more hinge barrels 216 on one side. The hinge barrels 214 of the first half shell 202 are in interdigitating relationship with the hinge barrels 216 of the second half shell 204 when more than one hinge barrel is provided on one of the first half shell 202 and the second half shell 204 such that at least one barrel on one half shell is positioned between two barrels on the other half shell. The hinge barrels 214 of the first half shell 202 are in alignment with the hinge barrels 216 of the second half shell 204 such that the bores of the hinge barrels 214 of the first half shell 202 are in alignment with the bores of the hinge barrels 216 of the second half shell 204. A hinge pin 218 is positioned to extend through the bores of the hinge barrels 214 of the first half shell 202 and the bores of the hinge barrels 216 of the second half shell 204 to thereby hinge or pivotally connect or attach the first half shell 202 to the second half shell 204. The hinge pin 218 defines the hinge axis of the hinged connection between the first half shell 202 and the second half shell 204 in that the hinge axis of the hinged connection between the first half shell 202 and the second half shell 204 coincides with the central longitudinal axis of the hinge pin 218.

When the first half shell 202 and the second half shell 204 are in the closed configuration and the latch 206 is engaged to the keeper 208, the latch 206 overlaps portions of both the first half shell 202 and the second half shell 204 on a side of the tubular shell 220 opposite the side of the tubular shell 220 on which the hinge axis is located.

The sandwich making utensil 200 further includes a bottom support 210 configured for supporting a sandwich stack received in the tubular shell 220. Each of the first half shell 202 and the second half shell 204 has a bottom, and the bottom support 210 is fixed to one of the first half shell 202 and the second half shell 204 at the bottom of the one of the first half shell 202 and the second half shell 204.

Alternatively, the tubular shell 220 has an open bottom when the first half shell 202 and the second half shell 204 are in the closed configuration, and the bottom support 210 fits in part into the bore of the tubular shell 220 to provide a closure for the open bottom of the tubular shell 220. In the illustrated embodiment, the bottom support 210 is in the form of a raised platform 222 having a perimeter and having a flange 224 of lower height around its perimeter.

The sandwich making utensil 200 also includes a pusher 212 configured for ensuring that all the items in the sandwich stack are packed close together with no gaps in between. The pusher 212 includes an elongated portion 226 configured for being capable of insertion into the bore of the tubular shell 220 to push the items in the sandwich stack together to eliminate any gaps between the items. The elongated portion 226 of the pusher 212 is preferably long enough to reach to the bottom support 210 through the bore of the tubular shell 220 without the pusher 212 falling completely into the bore of the tubular shell 220; however, the elongated portion 226 of the pusher 212 may be shorter than that length by an amount up to the height or thickness of the thinnest sandwich for which the use of the sandwich making utensil 200 is contemplated. In the illustrated embodiment, the pusher 212 has a bottom pushing surface 228 and a flange 230 projecting laterally from the perimeter of the top end of the pusher 212. The flange 230 at the top end of the pusher 212 is particularly useful for preventing pushers 212 having elongated portions 226 that are shorter than the height of the tubular shell 220 above the bottom support 210 from falling completely into the bore of the tubular shell 220.

In use, the sandwich making utensil 200 is first placed in the closed configuration by bringing together the edges 234 and 236 of the first half shell 202 and of the second half shell 204 that are on the side of each half shell that is located opposite the side of each half shell on which the hinge is located. The sandwich making utensil 200 is then secured in the closed configuration by engaging the latch 206 with the keeper 208.

In the illustrated example, the latch 206 is integral or of one-piece construction with the first half shell 202. Also, the keeper 208 is integral or of one-piece construction with the second half shell 204. The latch 206 includes a catch bar 238 of saw-tooth cross section. The latch 206 is flexible enough to allow the catch bar 238 to move between engaged and disengaged positions. The latch 206 is sufficiently resilient such that the internal resilience of the latch 206 returns the catch bar 238 from the disengaged position to the engaged position. As the edges 234 and 236 of the first half shell 202 and of the second half shell 204 are brought together, the catch bar 238 slips over the keeper 208 and moves behind the keeper, on the side of the keeper opposite the side of the keeper facing toward the edge 234 of the first half shell 202, such that the keeper 208 is captured between the catch bar 238 and the edge 234 of the first half shell 202, thus securing the two half shells in the closed configuration. The latch 206 also includes a tab 240 that allows a user to lift the catch bar 238 out of engagement with the keeper 208 in order to allow the half shells 202 and 204 to be moved relative to each other and to the open configuration.

Once the first half shell 202 and the second half shell 204 are secured in the closed configuration, the bottom support 210 will close off the bottom of the tubular shell 220, if the bottom support 210 is fixed to one of the half shells 202 and 204. If the bottom support 210 is a separate piece, then it can be inserted into the bottom of the tubular shell 220 to close off the bottom of the tubular shell 220. The tubular shell 220 is then placed on a counter top or table top with the bottom support 210 at the bottom of the tubular shell 220 adjacent the counter top or table top.

A piece of sandwich bread 242 can now be dropped down the bore of the tubular shell 220. If necessary, the pusher 212 can be used to properly seat the piece of sandwich bread 242 on the bottom support 210. Sandwich fillings 244 are then stacked on the piece of sandwich bread 242, one layer after another. The pusher 212 is used as necessary to pack the layers in the stack together such that there are no gaps between the layers. Finally, another piece of sandwich bread 246 is placed on top of the stack, with the pusher 212 being used to properly seat the piece of sandwich bread 246 on top of the stack if necessary.

Once the stacking of the sandwich ingredients is complete, the tubular shell 220 is opened up to allow removal of the completed sandwich from the sandwich making utensil 200. The sandwich can then be served, or it may be heated and/or further processed and then served depending on the recipe used or the wishes of the person who will eat the sandwich.

Preferably, the sandwich making utensil 100 and the sandwich making utensil 200 are made of molded plastic, although other materials and techniques may also be used in their construction, and such other materials and techniques are considered to be within the scope of the appended claims.

It must be understood that all permutations of the features of the various disclosed embodiments are contemplated as being part of the present invention. It is to be understood that the present invention is not limited to the embodiments described above, but encompasses any and all embodiments within the scope of the following claims.

1. A sandwich making utensil for making a sandwich including a sandwich stack made up of items selected from sandwich breads and sandwich fillings, the sandwich making utensil comprising:
a first half shell;
a second half shell, said second half shell being hinged to said first half shell, said first half shell and said second half shell being movable relative to each other between an open configuration and a closed configuration, said first half shell and said second half shell forming a tubular shell having a bore, a longitudinal axis, and at least an open top when said first half shell and said second half shell are in said closed configuration, said bore of said tubular shell having a cross sectional shape and size, said cross sectional shape and size being configured for receiving a predetermined type of sandwich bread of a predetermined size range, said first half shell and said second half shell being hinged together to move pivotally relative to each other between said open configuration and said closed configuration about a hinge axis, said hinge axis being parallel to said longitudinal axis of said tubular shell, and said hinge axis being located on one side of said tubular shell;
a latch provided on said first half shell; and
a keeper provided on said second half shell, said latch being capable of engaging said keeper in order to secure said first half shell and said second half shell in said closed configuration, and said latch being capable of being disengaged from said keeper in order to allow movement of said first half shell and said second half shell relative to each other so that said first half shell and said second half shell are capable of being moved to said open configuration.

2. The sandwich making utensil according to claim 1, wherein when said first half shell and said second half shell are in said closed configuration and said latch is engaged to said keeper, said latch overlaps portions of both said first half shell and said second half shell on a side of said tubular shell opposite said side of said tubular shell on which said hinge axis is located.

3. The sandwich making utensil according to claim 2, further comprising a bottom support configured for supporting a sandwich stack received in said tubular shell.

4. The sandwich making utensil according to claim 3, wherein each of said first half shell and said second half shell has a bottom, and wherein said bottom support is fixed to one of said first half shell and said second half shell at said bottom of said one of said first half shell and said second half shell.

5. The sandwich making utensil according to claim 3, wherein each of said first half shell and said second half shell has a bottom, wherein said tubular shell has an open bottom when said first half shell and said second half shell are in said closed configuration, and wherein said bottom support fits in part into said bore of said tubular shell and provides a closure for said open bottom of said tubular shell.

6. The sandwich making utensil according to claim 5, wherein said bottom support is in the form of a raised platform having a perimeter and having a flange of lower height around its perimeter.

7. The sandwich making utensil according to claim 3, further comprising a pusher configured for ensuring that all the items in the sandwich stack are packed close together with no gaps in between.

8. The sandwich making utensil according to claim 1, wherein said cross sectional shape of said bore of said tubular shell is circular for use with round types of sandwich bread.

9. The sandwich making utensil according to claim 8, wherein when said first half shell and said second half shell in said closed configuration and said latch is engaged to said keeper, said latch overlaps portions of both said first half shell and said second half shell on a side of said tubular shell opposite said side of said tubular shell on which said hinge axis is located.

10. The sandwich making utensil according to claim 9, further comprising a bottom support configured for supporting a sandwich stack received in said tubular shell.

11. The sandwich making utensil according to claim 10, wherein each of said first half shell and said second half shell has a bottom, and wherein said bottom support is fixed to one of said first half shell and said second half shell at said bottom of said one of said first half shell and said second half shell.

12. The sandwich making utensil according to claim 10, wherein each of said first half shell and said second half shell has a bottom, wherein said tubular shell has an open bottom when said first half shell and said second half shell are in said closed configuration, and wherein said bottom support fits in part into said bore of said tubular shell and provides a closure for said open bottom of said tubular shell.

13. The sandwich making utensil according to claim 12, wherein said bottom support is in the form of a raised platform having a perimeter and having a flange of lower height around its perimeter.

14. The sandwich making utensil according to claim 10, further comprising a pusher configured for ensuring that all the items in the sandwich stack are packed close together with no gaps in between.

15. The sandwich making utensil according to claim 1, wherein said cross sectional shape of said bore of said tubular shell is rectangular with rounded corners for use with rectangular types of sandwich bread.

16. The sandwich making utensil according to claim 15, further comprising a bottom support configured for supporting a sandwich stack received in said tubular shell.

17. The sandwich making utensil according to claim 16, wherein each of said first half shell and said second half shell has a bottom, and wherein said bottom support is fixed to one of said first half shell and said second half shell at said bottom of said one of said first half shell and said second half shell.

18. The sandwich making utensil according to claim 16, wherein each of said first half shell and said second half shell has a bottom, wherein said tubular shell has an open bottom when said first half shell and said second half shell are in said closed configuration, and wherein said bottom support fits in part into said bore of said tubular shell and provides a closure for said open bottom of said tubular shell.

19. The sandwich making utensil according to claim 18, wherein said bottom support is in the form of a raised platform having a perimeter and having a flange of lower height around its perimeter.

20. The sandwich making utensil according to claim 16, further comprising a pusher configured for ensuring that all the items in the sandwich stack are packed close together with no gaps in between.
